(19) United States
(12) Patent Application Publication
(10) Pub. No.: US 2019/0256432 A1
(43) Pub. Date: Aug. 22, 2019

(54) RECOVERY AND REUSE OF COMPONENTS FROM UREA FINISHING WASTE STREAMS

(71) Applicant: KOCH AGRONOMIC SERVICES LLC, Wichita, KS (US)

(72) Inventor: Dan Kuttenkuler, Wichita, KS (US)

(21) Appl. No.: 16/336,163

(22) PCT Filed: Oct. 12, 2017
(86) PCT No.: PCT/IB2017/056333

§ 371 Date: Mar. 25, 2019

Related U.S. Application Data
(60) Provisional application No. 62/407,618, filed on Oct. 13, 2016.

(51) Int. Cl. C05C 9/00; C05G 3/08; C05D 9/02; C05G 3/02; C05G 3/00

(52) U.S. Cl. CPC C05C 9/005; C05G 3/08; C05G 3/0058; C05G 3/02; C05D 9/02

(57) ABSTRACT

Methods are provided for recovering and reusing compounds from enhanced efficiency urea finishing facilities. Such methods can generally include collecting a liquid waste stream from a scrubber designed to purify exhaust waste streams; concentrating the liquid waste stream to produce a recovered material comprising 4% or less water by weight; combining the recovered material with virgin urea to give a mixture; and introducing the mixture into the enhanced efficiency urea finishing facility to be combined with one or more efficiency additives. A two-system arrangement for the performing of such methods is also described herein.

### CROSS REFERENCE TO RELATED APPLICATIONS

This present application is a national stage application of International Application No. PCT/M2017/056333, filed Oct. 12, 2017, and entitled “RECOVERY AND REUSE OF COMPONENTS FROM UREA FINISHING WASTE STREAMS”, which claims priority to U.S. Provisional Patent Application No. 62/407,618 filed Oct. 13, 2016 the disclosures of which are incorporated by reference herein.

### FIELD OF THE DISCLOSURE

The present subject matter relates generally to methods for recovering and reusing useful components from waste streams generated in urea-based fertilizer production processes.

### BACKGROUND OF THE INVENTION

Fertilizers, e.g., urea (CO(NH₂)₂) are widely used to provide nitrogen to soil to promote and enhance plant growth. When urea is applied to soil, it readily undergoes hydrolysis (catalyzed by urease, an enzyme produced by fungi and bacteria in soil) to form ammonia and carbon dioxide. Ammonia rapidly undergoes ionization to form ammonium that, along with ammonium nitrate, if present, is readily oxidized to nitrate (NO₃) via a series of bacterial oxidation reactions, referred to as “nitrification.” As a result, a large percentage of the nitrogen in urea is lost before plants can use it.

Consequently, much of the urea employed is in the form of so-called “enhanced efficiency” urea. Enhanced efficiency urea addresses these concerns by including specialty additives such as urease inhibitor(s) and/or nitrification inhibitors, micronutrients, specialty agriculture chemicals, or biologics. Urease inhibitors are compounds capable of inhibiting the catalytic activity of the urease enzyme on urea in the soil. Examples of urease inhibitors are the thiophosphoric triamide compounds disclosed in the U.S. Pat. No. 4,530,714, including N-(n-butyl) thiophosphoric triamide (NBPT), the most developed representative of this class of compounds. NBPT is commercially available for use in agriculture and is marketed in such products as the AGROTAIN® nitrogen stabilizer product line. Nitrification inhibitors are compounds capable of inhibiting the bacterial oxidation of ammonium to nitrate in the soil. Exemplary nitrification inhibitors include, but are not limited to, dicyandiamide (DCD). Micronutrients can include zinc, boron, and magnesium. Specialty agriculture chemicals can include pesticides, herbicides, fungicides, plant growth regulators, or plant hormones (e.g. strigalactones). Biologics can include live microorganisms (e.g. Bacillus or Pseudomonas species, fungi), exudates produced by live microorganisms (e.g. lipids), plant extracts, or microorganism fragments. Enhanced efficiency urea-based fertilizers may include various other additives, including, but not limited, to, dyes.

Such additives, e.g., urease inhibitors, nitrification inhibitors, micronutrients, specialty agriculture chemicals, biologics, and/or dyes can be associated with urea in various ways. For example, they can be coated onto fertilizer granules or mixed into fertilizer matrices. Commonly, such additives (in dry or solution form) are combined with urea in molten/melted form in a urea finishing facility to provide a homogenous mixture, which can be subsequently cooled and solidified in a subsequent granulation step. A number of granulation methods are known, including falling curtain, spheroidization-agglomeration drum granulation, prilling and fluid bed granulation technologies.

Such processes suffer from certain inefficiencies, e.g., as exhaust gas waste streams from such urea production facilities generally include urea dust, as well as low levels of the additives (e.g., urease inhibitors and/or nitrification inhibitors) that are combined within the urea. Consequently, these waste streams must be purified (e.g., using aqueous scrubbing technologies) before the waste streams may be released into the environment. Certain methods for purification of these waste streams are known; however, such known methods commonly introduce the aqueous scrubber solution in upstream processes of the urea production facility, and result in the introduction of the additives into the urea production facility where they may have detrimental effects on equipment, processes, and or products.

It would be beneficial to provide additional methods for removal of urea and additives from waste streams and, further, to provide methods for reusing these components.

### SUMMARY OF THE INVENTION

The present application relates to a method of recovering components present in urea finishing plant waste streams. In particular, such methods can provide recovery of urea, urease inhibitors, nitrification inhibitors, micronutrients, specialty agriculture chemicals, biologics and/or other components involved in the urea finishing process, which can enhance the efficiency of enhanced efficiency urea-based fertilizer production.

In one aspect, the present disclosure provides a method for recovering and reusing compounds from a waste stream of an enhanced efficiency urea finishing facility, the method comprising: collecting a liquid waste stream from a scrubber designed to purify waste air streams; concentrating the liquid waste stream to produce a concentrate comprising 4% or less water by weight; and combining the concentrate with virgin urea to give a mixture. The mixture can subsequently be introduced into the enhanced efficiency urea finishing facility to be combined with one or more efficiency additives. In some embodiments, the concentrating step further produces an evaporate and the method further comprises employing the evaporate as a scrubbing liquid in a scrubber designed to purify exhaust waste streams in the enhanced efficiency urea finishing facility.

A further aspect of the disclosure provides a two-system arrangement for production of enhanced efficiency urea, comprising an enhanced urea finishing system comprising a granulation unit and a liquid-containing scrubber unit to purify exhaust gases produced therefrom and an evaporation system, wherein: the liquid from the liquid-containing scrubber unit is directed into the evaporation system, the liquid is concentrated within the evaporation system to give a recycled liquid and a recovered material comprising 4% or less water by weight; the recycled liquid is directed back to the enhanced urea finishing system; and the recovered material is combined with urea and the resulting mixture is directed back to the enhanced urea finishing system.

### BRIEF DESCRIPTION OF THE DRAWINGS

In order to provide an understanding of embodiments of the invention, reference is made to the appended drawings, which are not necessarily drawn to scale, and in which reference numerals refer to components of exemplary embodiments of the invention. The drawings are exemplary only, and should not be construed as limiting the invention.

FIGS. 1-4 provide schematic representations of certain embodiments of the methods and systems disclosed herein.

### DETAILED DESCRIPTION OF THE INVENTION

It is noted here that as used in this specification and the appended claims, the singular forms “a,” “an,” and “the” include plural reference unless the context clearly dictates otherwise. All percentages, parts and ratios are based upon the total weight of the compositions of the present invention, unless otherwise specified. All such weights as they pertain to listed ingredients are based on the active level and, therefore do not include solvents or by-products that may be included in commercially available materials, unless otherwise specified. The term “weight percent” may be denoted as “wt. %” herein. All molecular weights as used herein are weight average molecular weights expressed as grams/mole, unless otherwise specified.

“Urea finishing” as used herein refers to a method wherein urea is provided in a solid, generally particulate form, generally comprising melting urea and cooling the molten urea to the desired particulate form (e.g., by prilling, granulating, or pelletizing). As such, a urea finishing facility is a facility wherein urea finishing is conducted, e.g., including facilities for melting urea and for cooling the molten urea.

“Enhanced efficiency urea finishing” involves not only providing urea in a solid, generally particulate form, but also incorporating one or more “efficiency additives,” including, but not limited to, urease inhibitors, nitrification inhibitors, micronutrients, specialty agriculture chemicals, and biologics within the urea (e.g., by mixing such additives with the molten urea and then cooling the mixture to the desired particulate form). The resulting product is referred to herein as “enhanced efficiency urea-based fertilizer,” which comprises urea and one or more efficiency additives, and which may further comprise other additives, e.g., dyes. An enhanced efficiency urea finishing facility is thus a facility wherein enhanced efficiency urea finishing is conducted to provide enhanced efficiency urea-based fertilizer.

In an enhanced efficiency urea finishing facility, exhaust gases are produced at various steps of enhanced efficiency urea-based fertilizer production and thus, exhaust gases are released from various places physically within an enhanced efficiency urea finishing facility. In some cases, such exhaust gases are released into the environment and/or are recycled back into the urea finishing process. Such exhaust gases can be released and/or recycled, e.g., from urea finishing plants generally, and/or more specifically from urea granulation towers and urea prilling towers. These exhaust gases commonly can include, not only gaseous and liquid components, but also such components as urea (e.g., in dust form) and additives employed in the finishing process (e.g., efficiency additives).

Before release of these exhaust gases into the environment or reuse of such gases within the urea finishing process, the gases are commonly purified e.g., by scrubbing. Scrubbing is a technique for gas purification wherein the gas to be treated/scrubbed is brought into contact with a fluid, wherein at least a portion of material present in the gas is removed to the fluid and the gas is thereby purified. Scrubbers can employ various fluids, e.g., aqueous fluids or organic fluids, and the fluids may comprise chemicals that specifically interact with the material to be removed the gas. Scrubbing techniques and relevant scrubbers can be selected from any wet-type scrubbers known in the industry, e.g., as summarized in Chemical Engineers' Handbook (Perry and Chilton), 5^{th} Ed. pp. 20-94 to 20-103, which is incorporated herein by reference in its entirety. Following contact with a scrubber, a purified gaseous stream is generally provided, along with a very dilute concentration (in the scrubber fluid) of components originally present in the gaseous stream (e.g., urea and/or efficiency additives, including, but not limited to, urease inhibitors and/or nitrification inhibitors, such as NBPT and/or DCD, micronutrients (e.g. boron, zinc, and magnesium), specialty agriculture chemicals, and biologics). Micronutrients can include zinc, boron, and magnesium. Specialty agriculture chemicals can include pesticides, herbicides, fungicides, plant growth regulators, or plant hormones (e.g. strigalactones). Biologics can include live microorganisms (e.g. Bacillus or Pseudomonas species, fungi), exudates produced by live microorganisms (e.g. lipids), plant extracts, or microorganism fragments.

According to the present disclosure, scrubbing and recycle liquid streams of an enhanced efficiency urea-based fertilizer finishing plant are collected and concentrated. The concentrating step is advantageously conducted within a separate system, which operates independently of the finishing plant. In other words, the fertilizer finishing plant generally has its own concentrating system (evaporator) and its output (including overhead condensate) may be routed to various locations (within the plant or outside the plant). The concentrating of the scrubbing and recycle liquid streams as disclosed herein advantageously is conducted within a concentrating system (evaporator) other than the concentrating system (evaporator) within the fertilizer finishing plant so that the function of the evaporator(s) used within the fertilizer finishing plant is not affected. As such, the presently described system provides dedicated components for the collection, storage, and concentration of scrubber fluid to give materials which can be reused in the process, minimizing detrimental effects on upstream equipment used within the existing fertilizer finishing plant.

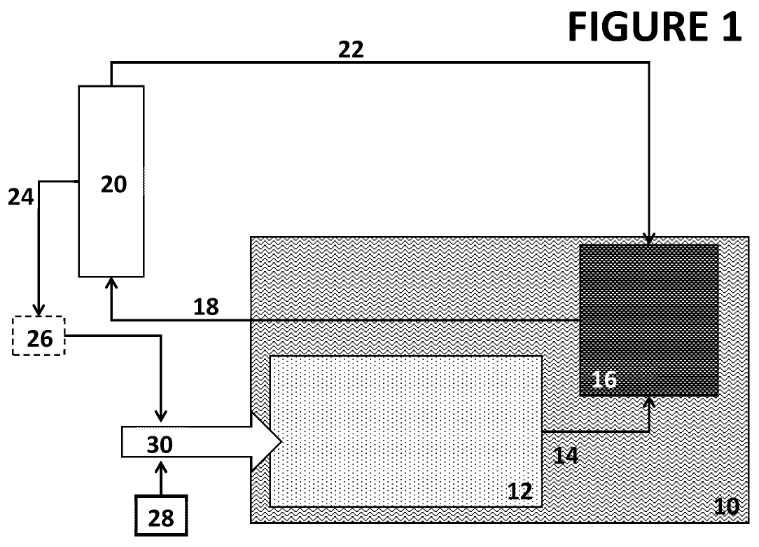

One exemplary system is illustrated in FIG. 1, wherein, within urea-based fertilizer finishing plant 10, a granulation unit 12 produces exhaust stream 14. The granulation unit 12 can comprise various numbers of granulators, e.g., granulation drum units and/or fluid bed granulation units. The exhaust stream 14, as noted herein above, can include such components as urea dust and enhanced efficiency additives (e.g., urease inhibitors, nitrification inhibitors, micronutrients, specialty agriculture chemicals, and biologics). The exhaust stream is passed through one or more scrubbers 16 to give a purified gaseous stream, which can be vented to the atmosphere, and a scrubber solution 18, which is directed to an evaporation system 20.

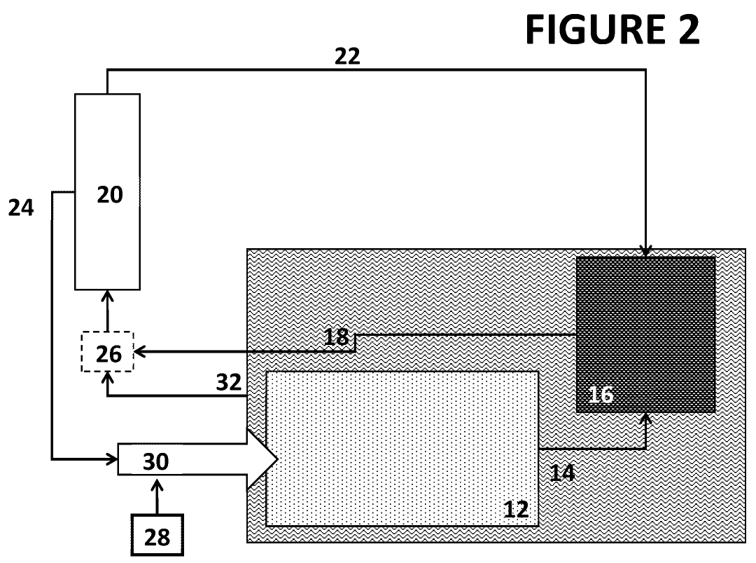

In another system, illustrated in FIG. 2, scrubber solution 18 is directed to a temporary holding tank 26. In certain embodiments, other streams can be directed to this holding tank 26. For example, as shown in FIG. 2, a washdown steam 32 from the plant can be directed to holding tank 26. Washdown stream 32 is a stream generally comprising water and components from granulation unit 12 (e.g., urea), which is produced upon cleaning/washing of the granulation unit with water. As shown, holding tank 26 is optional and either or both of streams 18 and 32 may, alternatively, be directed immediately to evaporation system 20. Within the evaporation system 20, liquids, e.g., the scrubbing liquid, are separated from other components present in the scrubber solution (i.e., urea dust and enhanced efficiency additives). The evaporation system can be any type of system capable of concentrating the liquid streams. Evaporation systems can have various numbers of stages, e.g., single or dual stage evaporator systems. Evaporation systems can comprise thermal evaporators, vacuum evaporators, or combinations thereof. The conditions employed within the evaporation system will vary, e.g., depending upon the specific scrubber solution used in scrubbers 16 and which is evaporated within evaporation system 20. In certain embodiments, the evaporation system 20 employs steam for the concentration of the material present in the scrubber solution.

At least a portion of the evaporated liquid component (the scrubbing liquid) is condensed and removed from the evaporation system, e.g., by condensate line 22, which can recycle the scrubbing liquid for reuse by directing it back to scrubber 16 (or into other scrubbers within fertilizer finishing plant 10 or elsewhere). The scrubbing liquid in condensate line 22 can, in some embodiments, be modified prior to reuse within the finishing plant, e.g., by the addition of more solvent thereto to provide the desired scrubbing liquid concentration. This scrubbing liquid recycling step provides a closed loop with regard to the scrubber solution, eliminating potential detrimental effects to upstream equipment, processes, and products.

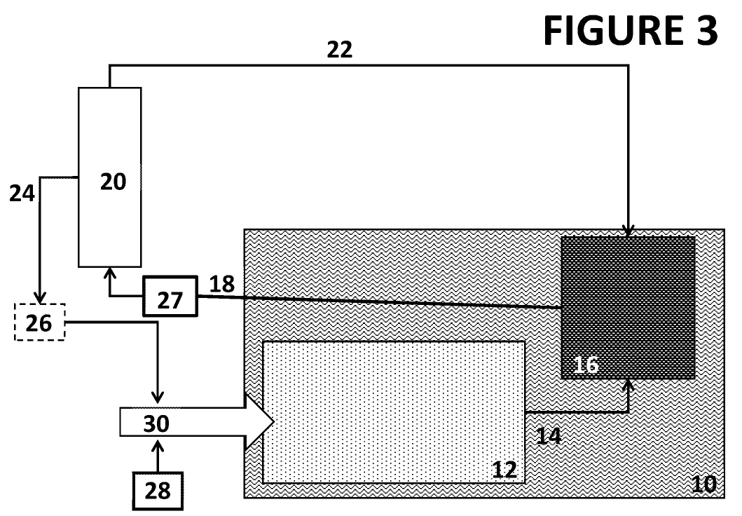

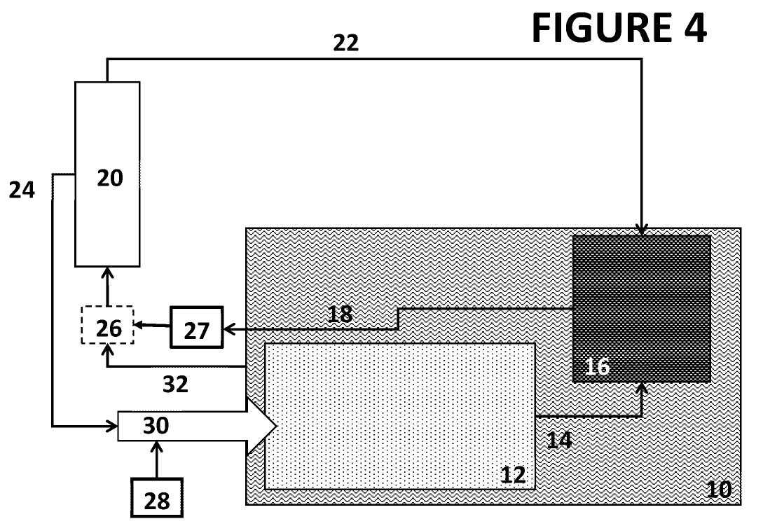

In a further system, illustrated in FIGS. 3 and 4, scrubber solution 18 first passes through a filtration system 27 prior to entering into the evaporation system 20 (FIG. 3) or holding tank 26 (FIG. 4). The filtration system removes additional solid material from the scrubber solution which is not captured in the scrubber 16. This is most advantageous when using micronutrients or biologics as enhanced efficiency additives. Typical filtration systems can include microfiltration with 0.1 to 10 μm pore sizes (e.g. hollow fiber membranes from Koch Membrane Systems, Inc.), which is most advantageous with micronutrients, and ultrafiltration with 0.01 to 0.1 μm pore sizes (e.g. TARGA™ II Series or PURPON® MP membranes from Koch Membrane Systems, Inc), which is most advantageous with biologics. In some instances where biologic exudates are used (e.g. lipids or proteins), then nanofiltration with 1-10 nm pore sizes can be used. If nanofiltration is used, it may be beneficial to first filter scrubber solution 18 with a microfiltration or ultrafiltration membrane to avoid fouling of the nanofiltration membrane. Further, if using an enhanced efficiency fertilizer with both micronutrients and biologics, two or more membranes in series (e.g. microfiltration followed by ultrafiltration and/or nanofiltration) can be used in the filtration system. As an alternative configuration, filtration system 27 can be placed in-line with line 24 (not shown). The enhanced efficiency additives captured in the filtration system may be recovered and re-used, by for example, filtration media washing.

The urea dust and enhanced efficiency additives resulting from the concentration of scrubber solution 18 are separately removed from evaporation system 20 by line 24. The additives recovered within the evaporation system are advantageously recovered in concentrated form, i.e., giving recovered material comprising urea dust and/or one or more enhanced efficiency additives with no more than 4% water by weight. In some embodiments, the recovered material comprises no more than 3%, no more than 2%, or in some cases, no more than 1% water by weight. The recovered material generally comprises primarily urea, e.g., about 95% by weight or greater urea, about 96% by weight or greater urea, about 97% by weight of greater urea, or about 98% by weight or greater urea.

This recovered material can be processed in various manners after being removed from the evaporation system. In some embodiments, the recovered material can be stored prior to use, in holding tank 26 as shown in FIG. 1, i.e., it is not directly sent back to the fertilizer finishing plant 10. In this context, storage facility 26 is a designated storage facility, i.e., not used for other materials generated within finishing plant 10. In other embodiments, the recovered material is directly reused within fertilizer finishing plant 10 (i.e., bypassing storage facility 26 and being injected directly into urea-containing stream 30).

It is noted that, where holding tank 26 within the disclosed system is used for purposes other than the specific storage of recovered material (before or after treatment within evaporation system 20), i.e., also used for storage of components within fertilizer finishing plant 10, the configuration shown in FIG. 1 is not advantageously employed, as the urea finishing plant 10 would suffer from contamination. As such, in FIG. 1, holding tank 26 is understood to be separate from any storage facilities used for components produced or used within urea finishing plant 10 (i.e., storage facility 26 stores only stream 24). Similarly, in FIG. 2, holding tank 26 is understood to be separate from any storage facilities used for components produced or used within urea finishing plant 10 (i.e., holding tank 26 stores only streams 18 and 32). Generally, in such systems, a separate holding tank would be employed (e.g., located upstream of the evaporator within urea finishing plant 10) for components produced or used within the plant.

The material recovered from the evaporator, i.e., stream 24 (with or without temporary storage) is advantageously combined with virgin urea 28 (e.g., in molten form) and this mixture 30 is introduced into the fertilizer finishing plant 10, e.g., into granulation unit 12. The virgin urea can include any type or types of urea, such as free urea, urea-formaldehyde products, and the like and additionally can include various substituted ureas. In certain embodiments, virgin urea remains the primary source of urea that is added to the granulation unit (e.g., with the recovered material used to introduce approximately 5-20% by weight of the urea introduced to the granulation unit, e.g., about 7-15% by weight, such as roughly 10% by weight of the urea in the mixture 30 introduced to the granulation unit). The amount of urea in the scrubber solution 18 is usually measured by density of the solution (based on calibration curves checked periodically by, e.g., wet chemistry or other direct concentration methods). Similarly, the amount of urea in the washdown stream 32 can be measured in such a manner. The amount or percentage of recovered material 24 combined with the virgin urea 28 is calculated usually by weight, stated as a percentage of the weight of virgin urea. Other components, e.g., urea-formaldehyde (UF), can optionally be added before or after combining the recovered material and virgin urea. As such, the mixture 30 introduced into the granulator can comprise a mixture of virgin urea, recovered material, and, in some embodiments, UF.

It is understood that FIGS. 1 through 4 provide oversimplifications of the represented systems, which further includes various components, including, but not limited to, pumps, condensers, heaters, additional scrubbers, gas purges, and the like. It is also noted that, although the disclosure herein and the associated figure focus on the recycling and reuse of components present in a liquid scrubbing stream, such components may be present elsewhere within the urea finishing plant 10 and the methods disclosed herein are generally applicable in those contexts as well. The disclosure also provides a two-system arrangement as generally described herein, employing an enhanced urea finishing system (e.g., comprising a granulation unit and scrubbers to scrub exhaust gases produced therefrom) and an evaporation system. Advantageously, as described herein, the two systems are in fluid communication with one another such that the scrubber fluid left behind after exhaust gases produced within the enhanced urea finishing system are scrubbed can be directed to the evaporation system and then, following treatment in the evaporation system, the resulting evaporated scrubbing liquid is returned to the enhanced urea finishing system for reuse in the same (or a different) scrubber therein.

Although the foregoing invention has been described in some detail by way of illustration and example for purposes of clarity of understanding, one of skill in the art will appreciate that certain changes and modifications may be practiced within the scope of the appended claims. In addition, each reference provided herein is incorporated by reference in its entirety to the same extent as if each reference was individually incorporated by reference. Where a conflict exists between the instant application and a reference provided herein, the instant application shall dominate.

1. A method for recovering and reusing compounds from an exhaust waste stream of an enhanced efficiency urea finishing facility, the method comprising:
collecting a liquid waste stream from a liquid-containing scrubber unit designed to purify exhaust waste streams;
concentrating the liquid waste stream to produce a recovered material comprising 4% or less water by weight;
combining the recovered material with virgin urea to give a mixture; and
introducing the mixture into the enhanced efficiency urea finishing facility to be combined with one or more efficiency additives.

2. The method of claim 1, wherein the recovered material comprises one or more compounds selected from urea, a urease inhibitor, a nitrification inhibitor, and mixtures thereof.

3. The method of claim 1, wherein the recovered material comprises micronutrients.

4. The method of claim 3, wherein the micronutrients are selected from boron, zinc, magnesium, and mixtures thereof.

5. The method of claim 1, wherein the recovered material comprises specialty agriculture chemicals.

6. The method of claim 5, wherein the specialty agriculture chemicals are selected from fungicides, pesticides, herbicides, and mixtures thereof.

7. The method of claim 1, wherein the recovered material comprises biologics.

8. The method of claim 2, wherein the urease inhibitor is N-(n-butyl)thiophosphoric triamide (NBPT).

9. The method of claim 2, wherein the nitrification inhibitor is dicyandiamide (DCD).

10. The method of claim 1, wherein the efficiency additives are selected from urea, urease inhibitors, nitrification inhibitors, micronutrients, specialty agriculture chemicals, biologics, and mixtures thereof.

11. The method of claim 1, wherein the concentrating step is conducted in an evaporation system.

12. The method of claim 1, wherein the concentrating step further produces an evaporate, and wherein the method further comprises:
employing the evaporate as a scrubbing liquid in a liquid-containing scrubber unit designed to purify exhaust waste streams in the enhanced efficiency urea finishing facility.

13. The method of claim 1, wherein the mixture comprises at least about 5% by weight urea from the recovered material.

14. The method of claim 1, wherein the mixture comprises about 5% to about 20% by weight urea from the recovered material.

15. The method of claim 1, wherein the recovered material is stored for a period of time prior to the combining step.

16. The method of claim 1, wherein the virgin urea is in molten form.

17. The method of claim 1, wherein the introducing step comprises introducing the mixture directly into a urea granulation system.

18. A two-system arrangement for production of enhanced efficiency urea, comprising an enhanced urea finishing system comprising a granulation unit and a liquid-containing scrubber unit to purify exhaust gases produced therefrom and an evaporation system,
wherein:
the liquid from the liquid-containing scrubber unit is directed into the evaporation system,
the liquid is concentrated within the evaporation system to give a recycled liquid and a recovered material comprising 4% or less water by weight;
the recycled liquid is directed back to the enhanced urea finishing system; and
the recovered material is combined with urea and the resulting mixture is directed back to the enhanced urea finishing system.
